(19) United States
(12) Patent Application Publication
(10) Pub. No.: US 2026/0080307 A1
(43) Pub. Date: Mar. 19, 2026

(54) INFORMATION PROCESSING APPARATUS, INFORMATION PROCESSING METHOD AND STORAGE MEDIUM

(71) Applicant: Kioxia Corporation, Tokyo (JP)

(72) Inventors: Youyang NG, Kamakura Kanagawa (JP); Yuji NOZAWA, Yokohama Kanagawa (JP); Shuhei IIJIMA, Yokohama Kanagawa (JP); Kazumoto NAKAMURA, Ota Tokyo (JP); Yuchieh LIN, Yokohama Kanagawa (JP)

(73) Assignee: Kioxia Corporation, Tokyo (JP)

(21) Appl. No.: 19/076,011

(22) Filed: Mar. 11, 2025

(30) Foreign Application Priority Data
Sep. 17, 2024 (JP) 2024-160316

(51) Int. Cl. G06N 20/00; G06F 18/213

(52) U.S. Cl. CPC G06N 20/00; G06F 18/213

(57) ABSTRACT

An information processing apparatus comprising processing circuitry configured to select analysis target data, select hint data related to a feature to be noted, construct a machine learning model that extracts a first feature included in the analysis target data and a second feature included in the hint data based on the selected analysis target data and the selected hint data, calculate a first index for evaluating the first feature, calculate a second index for evaluating the second feature, and update a weight of the machine learning model based on the first index and the second index.

### CROSS REFERENCE TO RELATED APPLICATIONS

This application is based upon and claims the benefit of priority from the prior Japanese Patent Application No. 2024-160316, filed on Sep. 17, 2024, the entire contents of which are incorporated herein by reference.

### FIELD

An embodiment of the present invention relates to an information processing apparatus, an information processing method and a storage medium.

### BACKGROUND

A machine learning model for extracting a feature included in input data has been proposed. Existing feature extraction processing includes a learning stage in which processing of inputting a plurality of pieces of teacher data with known features to a model and updating the weight of the model is repeated, and an inference stage in which inference target data is input to the learned model and a feature is extracted.

In the learning stage of the existing feature extraction processing, teacher data is often required. If appropriate teacher data cannot be prepared, the extraction accuracy of the feature in the inference stage cannot be improved.

For example, in a case of constructing a model for defect extraction in a manufacturing process of a semiconductor device, it is not easy to prepare, as teacher data, a large number of images including various defects that may occur in the manufacturing process.

### BRIEF DESCRIPTION OF THE DRAWINGS

FIG. 1 is a functional block diagram of a learning stage of an information processing apparatus according to a first embodiment;

FIG. 2 is a functional block diagram of an inference stage of the information processing apparatus according to the first embodiment;

FIG. 3 is a flowchart illustrating a processing operation in the learning stage of the information processing apparatus according to the first embodiment;

FIG. 4 is a diagram illustrating a structure of a vision transformer which is an example of a machine learning model constructed by a model construction unit;

FIG. 5 is a diagram illustrating an internal configuration of a transformer encoder;

FIG. 6 is a functional block diagram of a learning stage of an information processing apparatus according to a first modification;

FIG. 7 is a functional block diagram of a learning stage of an information processing apparatus according to a second modification;

FIG. 8 is a functional block diagram of a learning stage of an information processing apparatus according to a third modification;

FIG. 9 is a functional block diagram of a learning stage of an information processing apparatus according to a fourth modification;

FIG. 10 is a functional block diagram of a learning stage of an information processing apparatus according to a fifth modification;

FIG. 11 is a functional block diagram of a learning stage of an information processing apparatus according to a sixth modification;

FIG. 12 is a functional block diagram of a learning stage of an information processing apparatus according to a seventh modification;

FIG. 13 is a functional block diagram of a learning stage of an information processing apparatus according to an eighth modification;

FIG. 14 is a functional block diagram of a learning stage of an information processing apparatus according to a second embodiment; and

FIG. 15 is a flowchart illustrating a processing operation in the learning stage of the information processing apparatus according to the second embodiment.

### DETAILED DESCRIPTION

According to an embodiment of the present invention, there is provided an information processing apparatus comprising processing circuitry configured to select analysis target data, select hint data related to a feature to be noted, construct a machine learning model that extracts a first feature included in the analysis target data and a second feature included in the hint data based on the selected analysis target data and the selected hint data, calculate a first index for evaluating the first feature, calculate a second index for evaluating the second feature, and update a weight of the machine learning model based on the first index and the second index.

Hereinafter, embodiments of an information processing apparatus will be described with reference to the drawings. Although main components of the information processing apparatus will be mainly described below, the information processing apparatus may have components and functions that are not illustrated or described. The following description does not exclude the components and functions that are not illustrated or described.

### First Embodiment

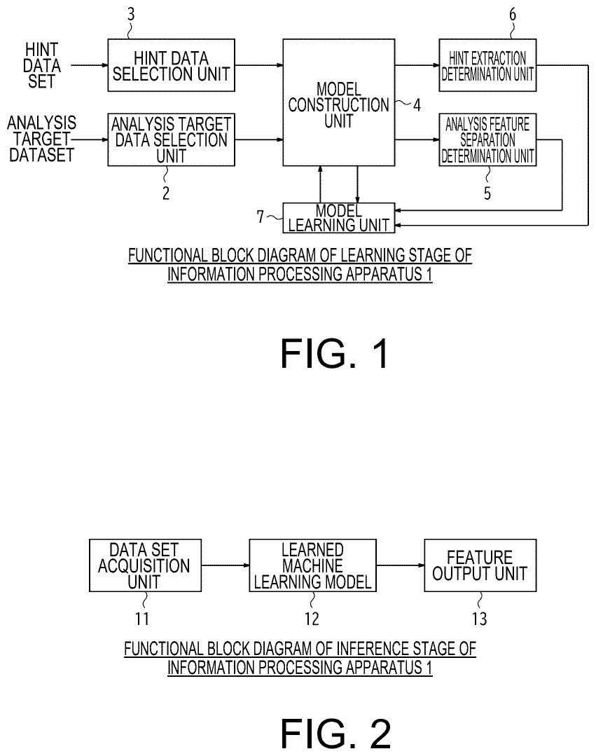

FIG. 1 is a functional block diagram of a learning stage of an information processing apparatus 1 according to a first embodiment. At least some functional blocks of the information processing apparatus 1 illustrated in FIG. 1 are configured by software or hardware. More specifically, the information processing apparatus 1 according to the first embodiment is provided in the form of, for example, a program executable by a computer, and the processing illustrated in the functional block diagram of FIG. 1 is performed by the computer executing the program. Alternatively, at least some functional blocks of the information processing apparatus 1 illustrated in FIG. 1 can be configured by hardware.

As illustrated in FIG. 1, the information processing apparatus 1 according to the first embodiment includes, in the learning stage, an analysis target data selection unit 2, a hint data selection unit 3, a model construction unit 4, an analysis feature separation determination unit 5, a hint extraction determination unit 6, and a model learning unit 7. the information processing apparatus 1 according to the first embodiment may be configured by using processing circuitry. The processing circuitry can implement processing operations of at least a part of the analysis target data selection unit 2, the hint data selection unit 3, the model construction unit 4, the analysis feature separation determination unit 5, the hint extraction determination unit 6, and the model learning unit 7.

The analysis target data selection unit 2 selects two or more pieces of input data from an analysis target data set input from the outside. The analysis target data set includes a plurality of pieces of analysis target data. In the specification, input data that is a target from which a feature is extracted may be referred to as analysis target data, and the analysis target data selection unit 2 may be referred to as a first selection unit. In the specification, an example in which the input data is image data will be mainly described, but the input data is not necessarily limited to the image data.

The hint data selection unit 3 selects hint data related to a feature to be noted from a hint data set input from the outside. The hint data set includes a plurality of pieces of hint data. The individual piece of hint data is not the feature itself to be noted, but is data including a hint from which the feature to be noted can be analogized. For example, a feature obtained by adding a slight noise to the feature to be noted may be used as the hint data. Alternatively, a feature similar to the feature to be noted may be used as the hint data. In the specification, the hint data selection unit 3 may be referred to as a second selection unit.

A correct answer label is not assigned to the analysis target data selected by the analysis target data selection unit 2 and the hint data selected by the hint data selection unit 3. The correct answer label is identification information corresponding to a feature. In the learning stage, the information processing apparatus 1 according to the first embodiment performs learning of a machine learning model without using teacher data to which the correct answer label is assigned.

The model construction unit 4 constructs a machine learning model that extracts an analysis target feature included in the analysis target data and a hint feature included in the hint data based on the analysis target data selected by the analysis target data selection unit 2 and the hint data selected by the hint data selection unit 3. The model construction unit 4 constructs an existing machine learning model such as a convolutional neural network (CNN) or a vision transformer (ViT), for example. Note that a specific type of the machine learning model constructed by the model construction unit 4 is arbitrary, and is not limited to a specific type of model such as CNN. In the specification, the analysis target feature extracted by the model construction unit 4 may be referred to as a first feature, and the hint feature may be referred to as a second feature.

The analysis feature separation determination unit 5 calculates a first index for evaluating the analysis target feature extracted by the model construction unit 4. The first index is, for example, a value (loss value) of a loss function representing the degree of separation of the analysis target feature. The smaller the loss value, the more remarkably the analysis target features are separated. The remarkable separation means that a difference between the analysis target features is clearly identified. In the specification, the analysis feature separation determination unit 5 may be referred to as a first index calculation unit. In addition, the analysis feature separation determination unit 5 assigns labels to the individual analysis target features.

The hint extraction determination unit 6 calculates a second index for evaluating the hint feature extracted by the model construction unit 4. The second index is, for example, a value (loss value) of a loss function representing the degree of extraction of the hint feature. The smaller the loss value, the higher the extraction accuracy of the hint feature. The hint extraction determination unit 6 assigns labels to the individual hint features.

The model learning unit 7 updates the weight of the machine learning model based on the first index and the second index. The information processing apparatus 1 according to the first embodiment repeatedly performs processing of updating the weight of the machine learning model in the model learning unit 7 for each batch including the analysis target data set and the hint data set.

FIG. 2 is a functional block diagram of an inference stage of the information processing apparatus 1 according to the first embodiment. As illustrated in FIG. 2, the information processing apparatus 1 according to the first embodiment includes, in the inference stage, a data set acquisition unit 11, a learned machine learning model 12, and a feature output unit 13. At least some functional blocks illustrated in FIG. 2 are configured by software or hardware.

The data set acquisition unit 11 acquires an analysis target data set including a plurality of pieces of analysis target data. The acquired analysis target data set is input to the learned machine learning model 12. The learned machine learning model 12 extracts a feature of each piece of the analysis target data included in the input analysis target data set. The feature output unit 13 outputs the features of the individual pieces of analysis target data included in the analysis target data set for each analysis target data set.

As described above, in the inference stage of the information processing apparatus 1 according to the first embodiment, the hint data is not used, and the analysis target data is input to the learned machine learning model 12 to extract the analysis target feature.

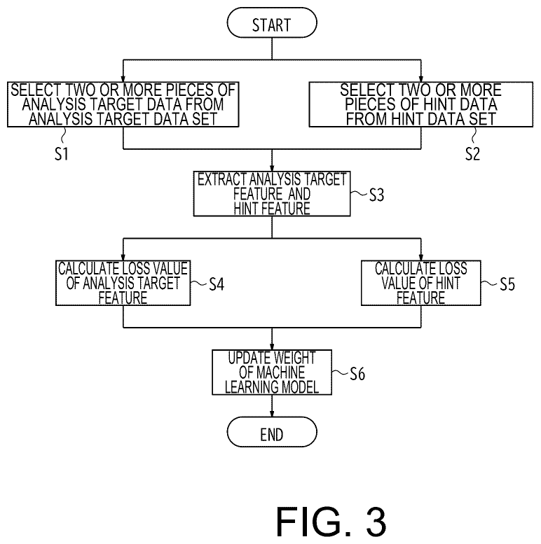

FIG. 3 is a flowchart illustrating a processing operation in the learning stage of the information processing apparatus 1 according to the first embodiment. The analysis target data selection unit 2 selects two or more pieces of analysis target data from the input analysis target data set (step S1). Before or after step S1, the hint data selection unit 3 selects two or more pieces of hint data from the input hint data set (step S2). As described above, the correct answer label is not assigned to the analysis target data selected in step S1 and the hint data selected in step S2.

Next, the model construction unit 4 inputs the analysis target data selected in step S1 and the hint data selected in step S2 to the machine learning model in the middle of learning, and extracts the analysis target feature and the hint feature (step S3).

Next, the analysis feature separation determination unit 5 calculates the value (loss value) of the loss function (first index) representing the degree of separation of the analysis target feature (step S4). Before or after step S4, the hint extraction determination unit 6 calculates the value (loss value) of the loss function (second index) representing the degree of extraction of the hint feature (step S5).

Next, the model learning unit 7 calculates the gradient of the weight of each stage of the machine learning model based on the two loss values (the first index and the second index) calculated in steps S4 and S5, and updates the weight of each stage based on the calculated gradient (step S6). The machine learning model has a hierarchical structure, and the weight can be updated for each hierarchical stage. In step S6, the weight of each stage of the machine learning model is updated based on the loss values calculated in steps S4 and S5.

In the learning stage, the processing of steps S1 to S6 is repeatedly performed for each of a plurality of batches.

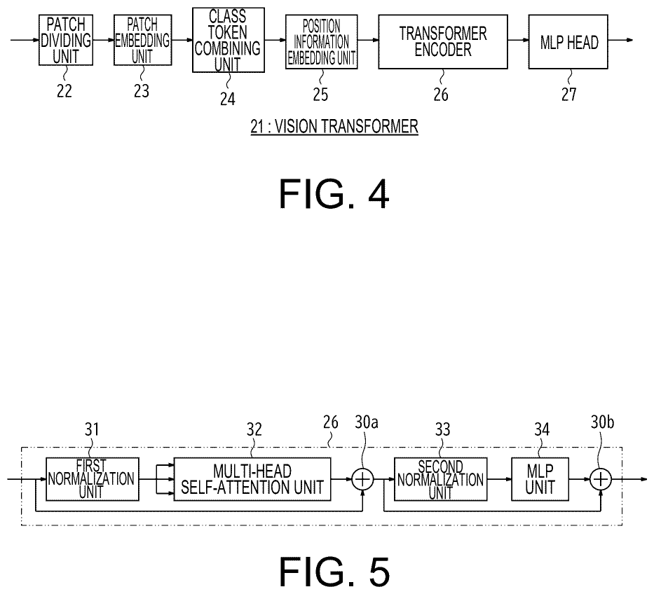

FIG. 4 is a diagram illustrating a structure of a vision transformer (ViT) 21 which is an example of the machine learning model constructed by the model construction unit 4. As illustrated in FIG. 4, the vision transformer 21 includes a patch dividing unit 22, a patch embedding unit 23, a class token combining unit 24, a position information embedding unit 25, a transformer encoder 26, and a multi layer perception (MLP) head 27.

The patch dividing unit 22 divides image data as input data into a plurality of patch images, and flattens each of the patch images to convert the patch image into a one-dimensional vector. This one-dimensional vector is called a token.

The patch embedding unit 23 performs classification by inputting the converted token to a fully-connected layer. The class token combining unit 24 combines a class token with the classified token. The position information embedding unit 25 combines position information with each token. The token to which the position information is combined is input to the transformer encoder 26. The transformer encoder 26 extracts a feature of the input image data.

FIG. 5 is a diagram illustrating an internal configuration of the transformer encoder 26. As illustrated in FIG. 5, the transformer encoder 26 includes a first normalization unit 31, a multi-head self-attention function 32, a second normalization unit 33, and an MLP unit 34.

The first normalization unit 31 performs normalization processing with an average and a standard deviation of the token itself to which the position information is combined by the position information embedding unit 25.

The multi-head self-attention function 32 extracts a feature by calculating self-attention (self-relevance degree) in parallel by a plurality of heads and obtaining attention (relevance degree) between the patch images. As described below, any head of the plurality of heads can be used to calculate the self-attention. The extracted feature differs depending on which head is used. An adder 30a is disposed on the output side of the multi-head self-attention function 32. The adder 30a performs residual connection for adding the output of the multi-head self-attention function 32 and the input of the first normalization unit 31. The residual connection is provided so that when a plurality of sets each including the first normalization unit 31 and the multi-head self-attention function 32 as one set are cascade-connected, some sets are skipped to cause the input of the first normalization unit 31 to be propagated to other sets, and the processing effect of each set is not lost.

The second normalization unit 33 normalizes the feature extracted by the multi-head self-attention function 32.

The MLP unit 34 has a fully-connected layer, an activation function, a dropout, and the like, and classifies the feature normalized by the second normalization unit 33. An adder 30b is disposed on the output side of the MLP unit 34. The adder 30b performs residual connection for adding the output of the MLP unit 34 and the input of the second normalization unit 33. The residual connection is provided so that when a plurality of sets each including the second normalization unit 33 and the MLP unit 34 as one set are cascade-connected, some sets are skipped to cause the input of the second normalization unit 33 to be propagated to other sets, and the processing effect of each set is not lost.

The MLP head 27 outputs the feature extracted by the transformer encoder 26.

Various modifications are conceivable in the functional block diagram of the learning stage of the information processing apparatus 1 according to the first embodiment illustrated in FIG. 1. Hereinafter, representative modifications of the functional block diagram in the learning stage will be sequentially described.

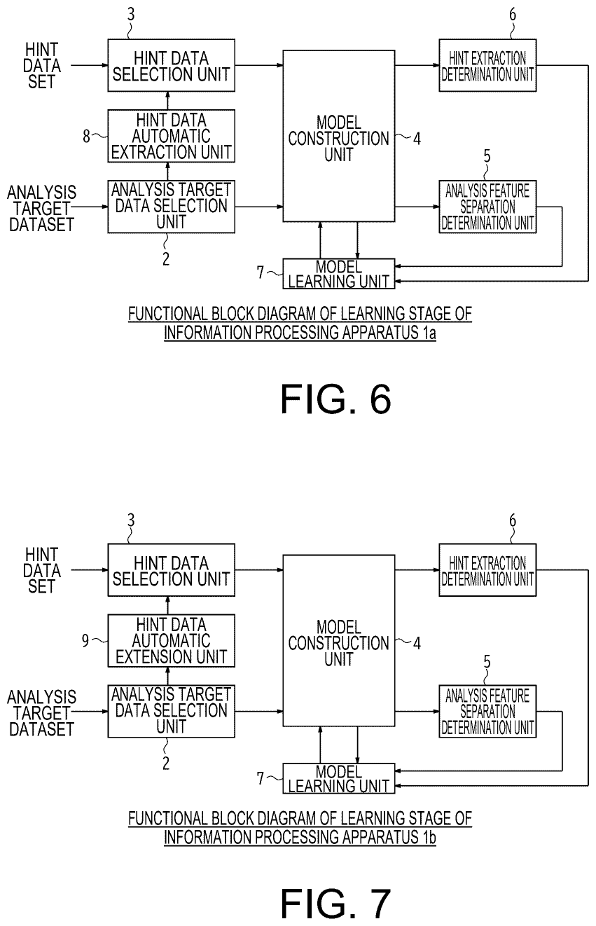

FIG. 6 is a functional block diagram of a learning stage of an information processing apparatus 1a according to a first modification. The information processing apparatus 1a according to the first modification illustrated in FIG. 6 includes a hint data automatic extraction unit 8 in addition to the configuration of the information processing apparatus 1 illustrated in FIG. 1. The hint data automatic extraction unit 8 selects two or more pieces of analysis target data from the analysis target data set input to the analysis target data selection unit 2. In the specification, the hint data automatic extraction unit 8 may be referred to as a hint extraction unit.

More specifically, the hint data automatic extraction unit 8 generates a histogram representing a feature distribution of the two or more pieces of analysis target data selected from the analysis target data set. This histogram is, for example, entropy of a plurality of pieces of analysis target data. The entropy is also called an average information amount, and is an index representing information randomness or uncertainty. The more random or uncertain the information, the higher the entropy. For example, the hint data automatic extraction unit 8 automatically extracts two or more pieces of analysis target data corresponding to outliers with low frequency based on the histogram representing the feature distribution of the plurality of pieces of analysis target data.

The two or more pieces of analysis target data automatically extracted by the hint data automatic extraction unit 8 are sent to the hint data selection unit 3. The hint data selection unit 3 selects, as hint data, the two or more pieces of analysis target data automatically extracted by the hint data automatic extraction unit 8.

As described above, in the information processing apparatus 1a according to the first modification, the processing of the hint data selection unit 3 can be simplified by providing the hint data automatic extraction unit 8. Since the hint data automatic extraction unit 8 automatically extracts the two or more pieces of analysis target data corresponding to the outliers of the histogram representing the feature distribution of the analysis target data set, the hint data related to the analysis target data can be easily extracted. The hint data is required to quickly and accurately extract the analysis target feature from the analysis target data, and sufficient consideration is required to select the hint data; however, since the outlier of the histogram described above is highly related to the analysis target data, if the hint data is automatically extracted from the outlier of the histogram, the analysis target feature can be quickly and accurately extracted from the analysis target data.

FIG. 7 is a functional block diagram of a learning stage of an information processing apparatus 1b according to a second modification. The information processing apparatus 1b according to the second modification illustrated in FIG. 7 includes a hint data automatic extension unit 9 in addition to the configuration of the information processing apparatus 1 illustrated in FIG. 1. The hint data automatic extension unit 9 selects two or more pieces of analysis target data having a feature similar to that of existing hint data. The existing hint data is generated by a user himself/herself and stored in a storage unit (not illustrated), for example. Alternatively, as described in the first modification, data automatically extracted from the outlier of the histogram may be used as the existing hint data. The hint data automatic extension unit 9 may select analysis target data having a feature extracted by the learned machine learning model 12 provided separately from the machine learning model in the learning stage in the model construction unit 4.

The two or more pieces of analysis target data selected by the hint data automatic extension unit 9 are sent to the hint data selection unit 3. The hint data selection unit 3 selects, as hint data, the two or more pieces of analysis target data selected by the hint data automatic extension unit 9.

The hint data automatic extension unit 9 selects the two or more pieces of analysis target data from the analysis target data set for each batch.

As described above, in the information processing apparatus 1b according to the second modification, by providing the hint data automatic extension unit 9, the two or more pieces of analysis target data having a feature similar to that of the existing hint data can be easily selected as new hint data. By providing the hint data automatic extension unit 9, the number of hint data can be increased without bothering the user.

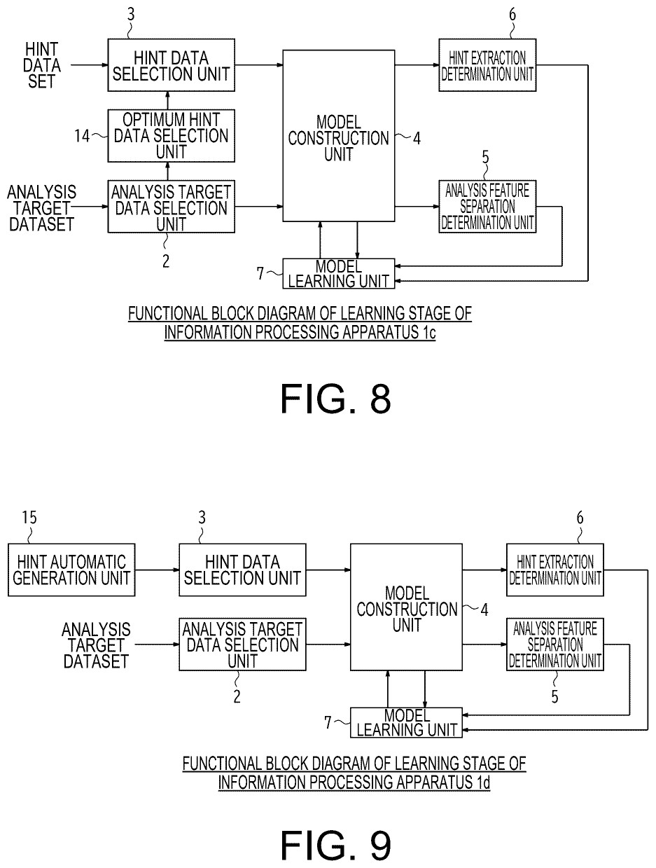

FIG. 8 is a functional block diagram of a learning stage of an information processing apparatus 1c according to a third modification. The information processing apparatus 1c according to the third modification illustrated in FIG. 8 includes an optimum hint data selection unit 14 in addition to the configuration of the information processing apparatus 1 illustrated in FIG. 1. The optimum hint data selection unit 14 selects N (N is an integer of 2 or more and M or less) pieces of analysis target data having similar features from M (M is an arbitrary integer of 2 or more) pieces of analysis target data selected by the analysis target data selection unit 2 for each batch. The optimum hint data selection unit 14 may select the N pieces of analysis target data having similar features extracted using the learned machine learning model 12 provided separately from the machine learning model in the learning stage in the model construction unit 4.

The N pieces of analysis target data selected by the optimum hint data selection unit 14 are sent to the hint data selection unit 3. The hint data selection unit 3 selects, as hint data, the N pieces of analysis target data selected by the optimum hint data selection unit 14.

As described above, in the information processing apparatus 1c according to the third modification, the N pieces of analysis target data having similar features are selected as the hint data from the M pieces of analysis target data selected by the analysis target data selection unit 2 for each batch, so that the processing of the hint data selection unit 3 can be simplified.

FIG. 9 is a functional block diagram of a learning stage of an information processing apparatus 1d according to a fourth modification. The information processing apparatus 1d according to the fourth modification illustrated in FIG. 9 includes a hint automatic generation unit 15 in addition to the configuration of the information processing apparatus 1 illustrated in FIG. 1. The hint automatic generation unit 15 generates two or more pieces of new hint data. For example, the hint automatic generation unit 15 generates new hint data based on information handwritten or input by the user. Alternatively, the hint automatic generation unit 15 may generate new hint data based on hint data selected in the past. Alternatively, the hint automatic generation unit 15 may generate new hint data using a data generator (not illustrated) or the like that adds random noise to existing analysis target data. In the specification, the hint automatic generation unit 15 may be referred to as a hint generation unit.

The two or more pieces of hint data generated by the hint automatic generation unit 15 are sent to the hint data selection unit 3. The hint data selection unit 3 selects the two or more pieces of hint data generated by the hint automatic generation unit 15.

As described above, in the information processing apparatus 1d according to the fourth modification, since the new hint data is generated, it is possible to save time and effort to input the hint data set from the outside.

The functions of the information processing apparatuses 1a to 1d according to the first to fourth modifications described above can be arbitrarily combined. That is, at least two or more of the hint data automatic extraction unit 8 in FIG. 6, the hint data automatic extension unit 9 in FIG. 7, the optimum hint data selection unit 14 in FIG. 8, and the hint automatic generation unit 15 in FIG. 9 may be added to the information processing apparatus 1 illustrated in FIG. 1.

The machine learning model constructed by the model construction unit 4 of each of the information processing apparatuses 1 to 1d illustrated in FIGS. 1 and 6 to 9 described above extracts the analysis target feature from the analysis target data and extracts the hint feature from the hint data using an updatable common weight. On the other hand, a second weight for extracting the hint feature may be provided separately from a first weight for extracting the analysis target feature.

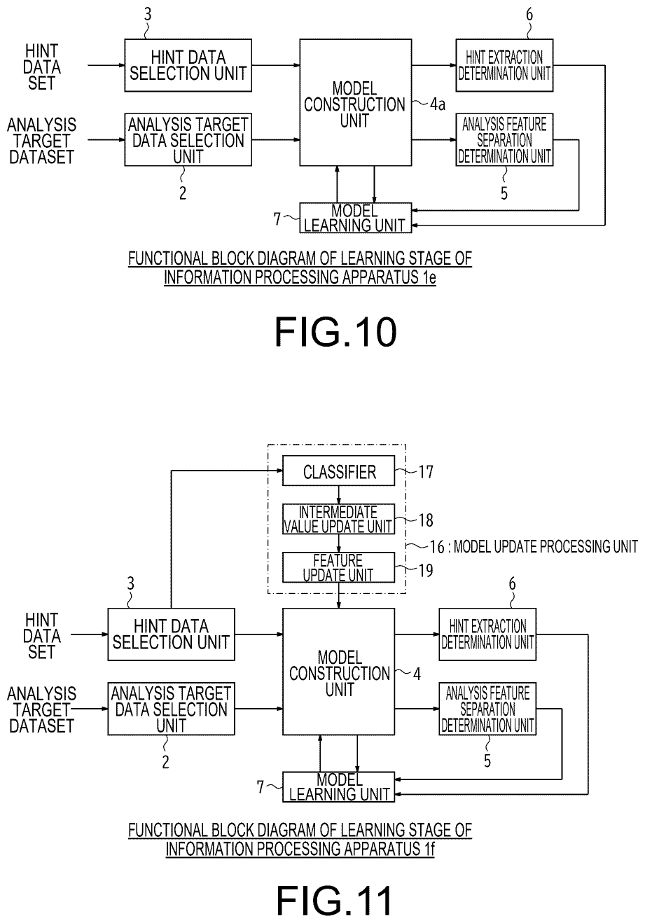

FIG. 10 is a functional block diagram of a learning stage of an information processing apparatus 1e according to a fifth modification. The information processing apparatus 1e according to the fifth modification illustrated in FIG. 10 includes a model construction unit 4a that constructs a machine learning model having a configuration different from that in FIG. 1. The machine learning model according to the fifth modification has the second weight for extracting the hint feature separately from the first weight for extracting the analysis target feature.

The model learning unit 7 updates the first weight for extracting the analysis target feature based on the loss value of the loss function calculated by the analysis feature separation determination unit 5, and updates the second weight for extracting the hint feature based on the loss value of the loss function calculated by the hint extraction determination unit 6.

The model construction unit 4a extracts the analysis target feature using the first weight updated by the model learning unit 7, and extracts the hint feature using the second weight updated by the model learning unit 7. Note that the model construction unit 4a in FIG. 10 is also applicable to the model construction unit 4 in FIGS. 1 and 6 to 9 described above.

As described above, in the information processing apparatus 1e according to the fifth modification, since the second weight for extracting the hint feature is provided separately from the first weight for extracting the analysis target feature, the analysis target feature and the hint feature can be extracted more accurately than the analysis target feature and the hint feature extracted with the common weight.

FIG. 11 is a functional block diagram of a learning stage of an information processing apparatus 1f according to a sixth modification. The information processing apparatus 1f according to the sixth modification illustrated in FIG. 11 includes a model update processing unit 16 in addition to the configuration of the information processing apparatus 1 in FIG. 1. The model update processing unit 16 includes a classifier 17, an intermediate value update unit 18, and a feature update unit 19.

The classifier 17 aggregates and classifies, as necessary, M (M is an integer of 2 or more) pieces of hint data selected by the hint data selection unit 3 into N (N is 2 or more and M or less) pieces of hint data, and updates the machine learning model.

The intermediate value update unit 18 updates some intermediate values for obtaining the analysis target feature and the hint feature based on the N pieces of hint data classified by the classifier 17.

The feature update unit 19 extracts the analysis target feature and the hint feature based on the some intermediate values updated by the intermediate value update unit 18.

As described above, in the information processing apparatus 1f according to the sixth modification, it is possible to extract the analysis target feature and the hint feature after updating some intermediate values of the machine learning model depending on the type of hint data.

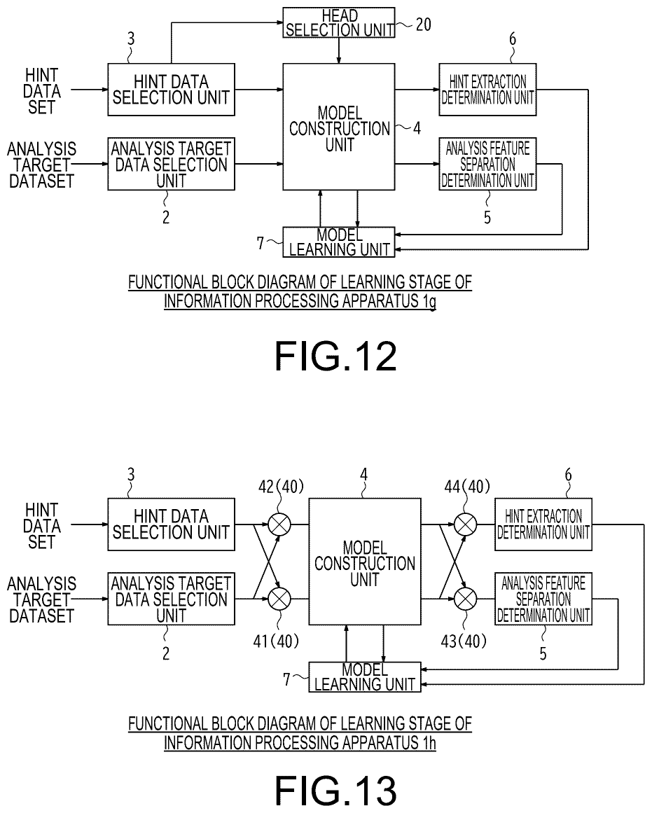

FIG. 12 is a functional block diagram of a learning stage of an information processing apparatus 1g according to a seventh modification. The information processing apparatus 1g according to the seventh modification illustrated in FIG. 12 includes a head selection unit 20 in addition to the configuration of the information processing apparatus 1 in FIG. 1.

While the machine learning model constructed by the model construction unit 4 of each of the information processing apparatuses 1a to 1f illustrated in FIGS. 1 and 6 to 11 described above may have any model form, it is assumed that the model construction unit 4 of the information processing apparatus 1g illustrated in FIG. 12 constructs the vision transformer 21 having the internal configuration illustrated in FIGS. 4 and 5.

As illustrated in FIG. 5, the vision transformer 21 includes the multi-head self-attention function 32. The multi-head self-attention function 32 has the plurality of heads that can be arbitrarily selected.

The information processing apparatus 1g according to the seventh modification illustrated in FIG. 12 includes the head selection unit 20. The head selection unit 20 aggregates and classifies, as necessary, M (M is an integer of 2 or more) pieces of hint data selected by the hint data selection unit 3 into N (N is 2 or more and M or less) pieces of hint data.

In the vision transformer 21 constructed by the model construction unit 4 in FIG. 12, the N pieces of hint data classified by the head selection unit 20 are input to N heads of the plurality of heads included in the multi-head self-attention function 32 illustrated in FIG. 5, and the other heads are invalidated.

As described above, in the information processing apparatus 1g according to the seventh modification, the head to be enabled can be switched in the plurality of heads included in the multi-head self-attention function 32 according to the type of the hint data, and the feature according to the hint data can be extracted.

FIG. 13 is a functional block diagram of a learning stage of an information processing apparatus 1h according to an eighth modification. The information processing apparatus 1h according to the eighth modification illustrated in FIG. 13 includes an interaction unit 40 in addition to the configuration of the information processing apparatus 1 in FIG. 1. The interaction unit 40 causes the hint data selected by the hint data selection unit 3 and the analysis target data selected by the analysis target data selection unit 2 to interact with each other to be input to the model construction unit 4, and causes the analysis target feature and the hint feature extracted by the machine learning model to interact with each other to be input to the analysis feature separation determination unit 5 and the hint extraction determination unit 6.

More specifically, the interaction unit 40 includes first to fourth interaction units 41 to 44.

The first interaction unit 41 inputs, to the model construction unit 4, analysis target data obtained by causing the hint data selected by the hint data selection unit 3 to interact with the analysis target data selected by the analysis target data selection unit 2.

The second interaction unit 42 inputs, to the model construction unit 4, hint data obtained by causing the analysis target data selected by the analysis target data selection unit 2 to interact with the hint data selected by the hint data selection unit 3.

The third interaction unit 43 inputs, to the analysis feature separation determination unit 5, an analysis target feature obtained by causing the hint feature extracted by the machine learning model to interact with the analysis target feature extracted by the machine learning model.

The fourth interaction unit 44 inputs, to the hint extraction determination unit 6, a hint feature obtained by causing the analysis target feature extracted by the machine learning model to interact with the hint feature extracted by the machine learning model.

As described above, in the information processing apparatus 1h according to the eighth modification, the analysis target data and the hint data are caused to interact with each other to be input to the model construction unit 4, and the analysis target feature and the hint feature extracted by the machine learning model are caused to interact with each other to calculate the value of the loss function of the analysis target feature and the value of the loss function of the hint feature, so that the analysis target feature can be extracted in consideration of the hint data.

As described above, in the first embodiment, since the learning of the machine learning model is performed using the hint data related to the feature to be noted, the learning of the machine learning model can be efficiently performed without the teacher data to which the correct answer label is assigned.

### Second Embodiment

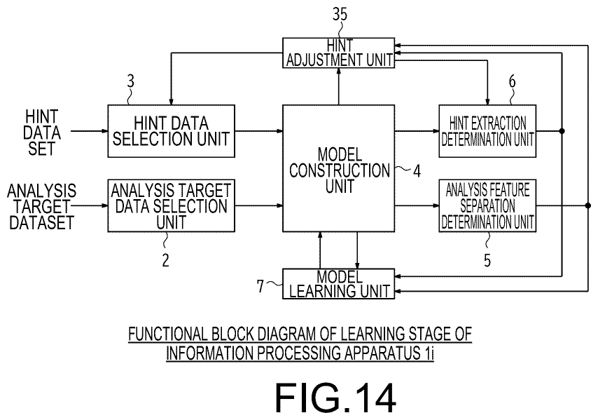

FIG. 14 is a functional block diagram of a learning stage of an information processing apparatus 1i according to a second embodiment. The information processing apparatus 1i according to the second embodiment illustrated in FIG. 14 includes a hint adjustment unit 35 in addition to the configuration of the information processing apparatus 1 in FIG. 1. The hint adjustment unit 35 adjusts at least one of the hint data selected by the hint data selection unit 3 and the weight for calculating the loss function (second index) calculated by the hint extraction determination unit 6 based on at least one of a relationship between the loss function (first index) calculated by the analysis feature separation determination unit 5 and the loss function (second index) calculated by the hint extraction determination unit 6 and a relationship between a distance between the analysis target features and a distance between the hint features.

For example, the hint adjustment unit 35 may perform first processing for making the weight of the loss value calculated by the hint extraction determination unit 6 smaller when a value obtained by dividing the loss value calculated by the hint extraction determination unit 6 by the loss value calculated by the analysis feature separation determination unit 5 exceeds a first threshold, and making the weight of the loss value calculated by the hint extraction determination unit 6 larger when the value is equal to or less than the first threshold.

Alternatively, the hint adjustment unit 35 may perform second processing for making the weight of the loss value calculated by the hint extraction determination unit 6 smaller when a value obtained by dividing the distance between the hint features by the distance between the analysis target features exceeds a second threshold, and making the weight of the loss value calculated by the hint extraction determination unit 6 larger when the value is equal to or less than the second threshold.

Alternatively, in a case where the hint data is image data, the hint adjustment unit 35 may perform third processing for making the contrast of the hint data to be selected next by the hint data selection unit 3 higher when the value obtained by dividing the loss value calculated by the hint extraction determination unit 6 by the loss value calculated by the analysis feature separation determination unit 5 exceeds a third threshold, and making the contrast of the hint data to be selected next by the hint data selection unit 3 lower when the value is equal to or less than the third threshold.

Alternatively, in a case where the hint data is image data, the hint adjustment unit 35 may perform fourth processing for making the contrast of the hint data to be selected next by the hint data selection unit 3 higher when the value obtained by dividing the distance between the hint features by the distance between the analysis target features exceeds a fourth threshold, and making the contrast of the hint data to be selected next by the hint data selection unit 3 lower when the value is equal to or less than the fourth threshold value.

The hint adjustment unit 35 performs, for example, at least one of the first to fourth processing described above. For example, the hint data selection unit 3 selects the hint data adjusted by the hint adjustment unit 35. In addition, for example, the hint extraction determination unit 6 adjusts the hint feature using the weight adjusted by the hint adjustment unit 35.

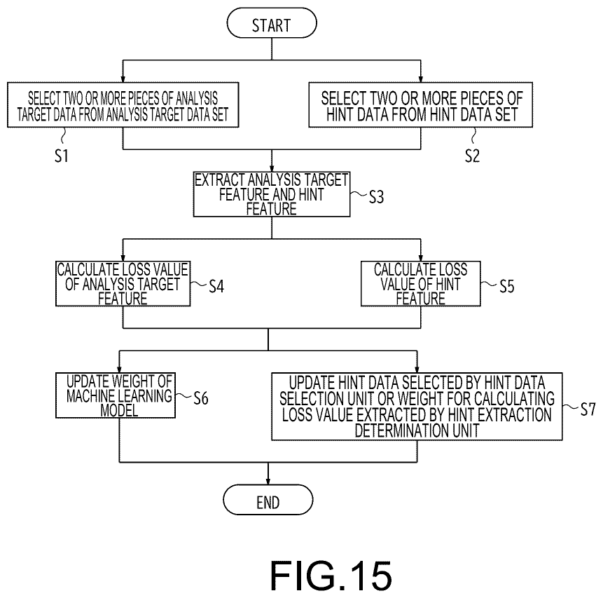

FIG. 15 is a flowchart illustrating a processing operation in the learning stage of the information processing apparatus 1i according to the second embodiment. In FIG. 15, the same processing as that in FIG. 3 is denoted by the same step number, and hereinafter, processing different from that in FIG. 3 will be mainly described.

The hint adjustment unit 35 adjusts at least one of the hint data selected by the hint data selection unit 3 and the weight for calculating the loss function (second index) calculated by the hint extraction determination unit 6 based on the loss function (first index) calculated in step S4, the loss function (second index) calculated in step S5, and the distance between the analysis target features and the distance between the hint features extracted in step S3 (step S7).

As described above, in the second embodiment, at least one of the adjustment of the hint data and the adjustment of the weight for calculating the loss value of the hint feature is performed based on the extracted features and the calculated loss values, so that the hint data and the hint feature can be optimized simply and accurately.

At least a part of the information processing apparatuses 1 to 1i described in the above-described embodiments may be configured by hardware or software. In a case where at least a part of the information processing apparatuses is configured by software, a program for realizing at least some functions of the information processing apparatuses 1 to 1i may be stored in a storage medium such as a flexible disk or a CD-ROM, and may be read and executed by a computer. The storage medium is not limited to a removable storage medium such as a magnetic disk or an optical disk, and may be a fixed storage medium such as a hard disk device or a memory.

In addition, the program for realizing at least some functions of the information processing apparatuses 1 to 1i may be distributed via a communication line (including wireless communication) such as the Internet. Further, the program may be distributed via a wired line or a wireless line such as the Internet or stored in a storage medium in an encrypted, modulated, or compressed state.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

1. An information processing apparatus comprising processing circuitry configured to:
select analysis target data;
select hint data related to a feature to be noted;
construct a machine learning model that extracts a first feature included in the analysis target data and a second feature included in the hint data based on the selected analysis target data and the selected hint data;
calculate a first index for evaluating the first feature;
calculate a second index for evaluating the second feature; and
update a weight of the machine learning model based on the first index and the second index.

2. The information processing apparatus according to claim 1, wherein the processing circuitry is further configured to
adjust at least one of the selected hint data and a weight for calculating the second index based on at least one of a relationship between the first index and the second index and a relationship between a distance between the first features and a distance between the second features.

3. The information processing apparatus according to claim 2, wherein
the adjusted hint data is selected.

4. The information processing apparatus according to claim 2, wherein
the second index is adjusted using the adjusted weight.

5. The information processing apparatus according to claim 2, wherein
a weight of the second index is made smaller when a value obtained by dividing the second index by the first index exceeds a first threshold, and the weight of the second index is made larger when the value is equal to or less than the first threshold.

6. The information processing apparatus according to claim 2, wherein
a weight of the second index is made smaller when a value obtained by dividing the distance between the second features by the distance between the first features exceeds a second threshold, and the weight of the second index is made larger when the value is equal to or less than the second threshold.

7. The information processing apparatus according to claim 2, wherein
the hint data is image data, and
contrast of the hint data to be selected next is made higher when a value obtained by dividing the second index by the first index exceeds a third threshold, and the contrast of the hint data to be selected next is made lower when the value is equal to or less than the third threshold.

8. The information processing apparatus according to claim 2, wherein
the hint data is image data, and
contrast of the hint data to be selected next is made higher when a value obtained by dividing the distance between the second features by the distance between the first features exceeds a fourth threshold, and the contrast of the hint data to be selected next is made lower when the value is equal to or less than the fourth threshold.

9. The information processing apparatus according to claim 1, wherein
two or more pieces of the analysis target data are selected from a plurality of pieces of the analysis target data input, and
two or more pieces of the hint data are selected from a plurality of pieces of the hint data input separately from the plurality of pieces of analysis target data.

10. The information processing apparatus according to claim 1, wherein
the processing circuitry is further configured to extract two or more pieces of the analysis target data based on a feature distribution of a plurality of pieces of the analysis target data, and
the extracted two or more pieces of analysis target data are selected as two or more pieces of the hint data.

11. The information processing apparatus according to claim 10, wherein
the two or more pieces of hint data are extracted from outliers of the feature distribution of the plurality of pieces of analysis target data.

12. The information processing apparatus according to claim 1, wherein
the processing circuitry is further configured to extract two or more pieces of the analysis target data having a feature similar to a feature of the hint data from a plurality of pieces of the analysis target data, and
the extracted two or more pieces of analysis target data are selected as two or more pieces of the hint data.

13. The information processing apparatus according to claim 1, wherein
processing in which two or more pieces of the analysis target data are selected and processing in which two or more pieces of the hint data are selected are repeatedly performed for each of batches,
the processing circuitry is further configured to select, for each of the batches, two or more pieces of the analysis target data having similar features from a plurality of pieces of the analysis target data, wherein
the selected two or more pieces of analysis target data are selected, for each of the batches, as two or more pieces of the hint data.

14. The information processing apparatus according to claim 1, wherein
the processing circuitry is further configured to generate the hint data, and
the generated hint data are selected.

15. The information processing apparatus according to claim 1, wherein
a first weight for extracting the first feature is updated based on the first index and a second weight for extracting the second feature is updated based on the second index, and
the first feature is extracted by using the updated first weight and the second feature is extracted by using the updated second weight.

16. The information processing apparatus according to claim 1, wherein
the processing circuitry is further configured to classify M (M is an integer of 2 or more) pieces of the selected hint data into N (N is 2 or more and M or less) pieces of hint data and update the machine learning model,
intermediate values for obtaining the first feature and the second feature are updated based on the N pieces of hint data, and
the first feature and the second feature are extracted after updating the intermediate values.

17. The information processing apparatus according to claim 1, wherein
the processing circuitry is further configured to classify M (M is an integer of 2 or more) pieces of the selected hint data into N (N is 2 or more and M or less) pieces of hint data,
a vision transformer is constructed including a multi-head self-attention function, and
in N or more heads included in the multi-head self-attention function, the classified N pieces of hint data are input to the N heads, and the other heads are invalidated.

18. The information processing apparatus according to claim 1, wherein the processing circuitry is further configured to cause the selected analysis target data and the selected hint data to interact with each other to construct the machine learning model, and cause the first feature and the second feature extracted by the machine learning model to interact with each other to calculate the first index and the second index.

19. The information processing apparatus according to claim 1, wherein
the first index is a value of a first loss function representing a degree of separation between the first features, and
the second index is a value of a second loss function representing a degree of extraction of the second feature.

20. The information processing apparatus according to claim 1, wherein
a label is not assigned to the selected analysis target data,
a label is not assigned to the selected hint data,
a label corresponding to the first feature is assigned, and
a label corresponding to the second feature is assigned.

21. An information processing method comprising:
selecting analysis target data;
selecting hint data related to a feature to be noted;
constructing a machine learning model that extracts a first feature included in the analysis target data and a second feature included in the hint data based on the selected analysis target data and the selected hint data;
calculating a first index for evaluating the first feature;
calculating a second index for evaluating the second feature; and
updating a weight of the machine learning model based on the first index and the second index.

22. A non-transitory computer-readable storage medium storing a program executed by a computer, the medium causing the computer to execute:
selecting analysis target data;
selecting hint data related to a feature to be noted;
constructing a machine learning model that extracts a first feature included in the analysis target data and a second feature included in the hint data based on the selected analysis target data and the selected hint data;
calculating a first index for evaluating the first feature;
calculating a second index for evaluating the second feature; and
updating a weight of the machine learning model based on the first index and the second index.
